(19) United States
(12) Patent Application Publication
(10) Pub. No.: US 2026/0279187 A1
(43) Pub. Date: Sep. 17, 2026

(54) Emergency Response Incident Handling

(71) Applicant: Dräger Safety AG & Co. KGaA, Lübeck (GB)

(72) Inventors: Samuel John Kennedy, Newcastle upon Tyne (GB); Larry Qing Lu, Leeds (GB)

(21) Appl. No.: 19/561,920

(22) Filed: Mar. 10, 2026

(30) Foreign Application Priority Data
Mar. 11, 2025 (EP) 25163102.4

(51) Int. Cl. G08B 25/00; G08B 7/06; G08B 21/02; G08B 25/01; G08B 25/10

(52) U.S. Cl. CPC G08B 25/009; G08B 7/066; G08B 21/02; G08B 25/016; G08B 25/10

(57) ABSTRACT

There is disclosed a system for monitoring an emergency response incident. The system comprises one or more wearable devices of a network. The one or more wearable devices are deployed at the emergency response incident. The system comprises a plurality of network nodes of the network. The plurality of network nodes is deployed at the emergency response incident. The plurality of network nodes is configured to provide network coverage in a first geographical area of the emergency response incident. Each network node of the plurality of network nodes is configured to obtain information indicative of at least one environmental condition associated with a bounding region of the network node. The first geographical area comprises the bounding region. Each network node of the plurality of network nodes is configured to, if the obtained information meets a first criterion, initiate transmission of an alert towards at least one wearable device of the one or more wearable devices.

### CROSS-REFERENCE TO RELATED APPLICATIONS

This application claims priority to European Application No. 25 163 102.4, filed on Mar. 11, 2025 and entitled “Emergency Response Incident Handling,” the entirety of which is hereby incorporated by reference in its entirety for all non-limiting purposes.

### TECHNICAL FIELD

The present application relates to systems and methods for monitoring an emergency response incident.

### BACKGROUND

Fighting wildland fires presents a unique set of challenges not ordinarily faced in structural firefighting. In these situations, firefighters face navigating vast and remote terrains, and experience rapidly changing fire conditions and communication difficulties. These risks are further amplified by prolonged periods of physical exertion and exposure to extreme heat, with very limited or non-existent access to immediate medical assistance.

A number of tragic incidents, such as the South Canyon Fire (1993—14 fatalities) and the Yarnell Hill Fire (2013—19 fatalities) further highlight the significant dangers that wildland firefighting poses. Burnovers, entrapments, medical incidents (especially heart attacks) and falling debris accounted for the majority of wildland firefighter deaths between 2007 and 2016. In these situations, firefighters need as much warning as possible to have the best chance of escape, and even a delay of several seconds can be the difference between life and death. By way of example, the last surviving crew member of the South Canyon Fire was estimated to have had just 5 seconds to spare after their escape.

It will therefore be appreciated that advancements in monitoring emergency response incidents (e.g. wildland fires) are highly desirable.

### SUMMARY

As mentioned above, there are challenges associated with monitoring emergency response incidents. Many existing techniques for handling emergency response incidents rely on manual reporting of conditions between personnel at the incident (e.g., using one or more walkie-talkies). However, such existing techniques rely on the responsiveness located at the incident and thus can cause serious, and potentially life-threatening, delays. Moreover, such existing techniques can be burdened by inaccurate monitoring and thus lead to ineffective incident handling. There is therefore a desire to provide a technique that enables safe and efficient handling of an emergency response incident.

According to a first aspect of the disclosure, there is provided a system for monitoring an emergency response incident. The system comprises one or more wearable devices of a network. The one or more wearable devices are deployed at the emergency response incident. The system comprises a plurality of network nodes of the network. The plurality of network nodes is deployed at the emergency response incident. The plurality of network nodes is configured to provide network coverage in a first geographical area of the emergency response incident. Each network node of the plurality of network nodes is configured to obtain information indicative of at least one environmental condition associated with a bounding region of the network node. The first geographical area comprises the bounding region. Each network node of the plurality of network nodes is configured to, if the obtained information meets a first criterion, initiate transmission of an alert towards at least one wearable device of the one or more wearable devices.

Monitoring an emergency response incident may comprise handling information associated with an emergency response incident. The system may be an emergency response incident handling system.

Each wearable device of the one or more wearable devices may be comprised in a bounding region of a network node of the plurality of network nodes. Each wearable device being comprised in a bounding region may include each wearable device being (e.g. geographically) located within the bounding region.

Each network node of the plurality of network nodes may be configured to, if the obtained information meets the first criterion, initiate transmission of the alert towards each wearable device of the one or more wearable devices comprised in the bounding region of the network node.

Each network node of the plurality of network nodes may be configured to identify a change in the at least one environmental condition based on the obtained information. The first criterion may be met if the change in the at least one environmental condition is indicative of a hazard in the bounding region.

The at least one environmental condition may comprise one or more of: wind speed, wind direction, humidity, temperature, sound, infrared radiation, ultraviolet radiation, carbon monoxide concentration, carbon dioxide concentration, volatile organic compounds concentration, oxygen concentration, and/or smoke particulate concentration.

The change in the at least one environmental condition may comprise an increase in: wind speed, humidity, temperature, infrared radiation, ultraviolet radiation, carbon monoxide concentration, carbon dioxide concentration, volatile organic compounds concentration, oxygen concentration, and/or smoke particulate concentration. Alternatively, or in addition, the change in the at least one environmental condition may comprise a decrease in: wind speed and/or humidity. Alternatively, or in addition, the change in the at least one environmental condition may comprise a change in: wind direction, and/or sound.

The first geographical area may comprise an escape route. If a bounding area of a network node of the plurality of network nodes at least partially comprises the escape route, the network node may be configured to determine a condition of the escape route based on the obtained information. In some examples, if the condition of the escape route is determined to be unstable, the network node may be configured to initiate transmission of an evacuation instruction towards each wearable device in the bounding region of the network node.

The one or more wearable devices may be configured to, in response to receiving the evacuation instruction, generate a notification indicative that the escape route is unstable.

The system may further comprise a wireless device of the network. The wireless device may comprise a user interface. Each network node of the plurality of network nodes may be configured to, if the obtained information meets the first criterion, initiate transmission of the alert towards the wireless device.

The at least one wearable device may be configured to, in response to receiving the alert, generate a notification indicative that the obtained information meets the first criterion.

Each network node of the plurality of network nodes may comprise at least one sensor. The at least one sensor may be configured to obtain (e.g., measure) the information indicative of the at least one environmental condition.

The emergency response incident may be one or more of: a fire, a wildfire, a surface fire, a crown fire, a canopy fire, a wildland fire, a forest fire, and a bushfire.

According to a second aspect of the disclosure, there is disclosed a method for monitoring an emergency response incident. The method comprises obtaining, by a network node of a network, information indicative of at least one environmental condition associated with a bounding region of the network node. The network node is one of a plurality of network nodes of the network. The plurality of network nodes is deployed at the emergency response incident. The plurality of network nodes is configured to provide network coverage in a first geographical area. The first geographical area comprises the bounding region. The method also comprises, if the obtained information meets a first criterion, initiating, by the network node, transmission of an alert towards at least one wearable device of one or more wearable devices of the network. The one or more wearable devices are deployed at the emergency response incident.

The method may be a computer-implemented method.

The method may comprise identifying, by the network node, a change in the at least one environmental condition based on the obtained information. The first criterion may be met if the change in the at least one environmental condition is indicative of a hazard in the bounding region.

According to a further aspect, there is disclosed a computer program product, embodied on a non-transitory machine-readable medium, comprising instructions which are executable by processing circuitry to cause the processing circuitry to perform the method as described herein.

The technique described herein provide improvements to monitoring an emergency response incident. By automatically notifying a wearer of a wearable device (e.g., a firefighter) of a change in at least one environmental condition (e.g., rather than waiting for such a change to be manually communicated to them) the wearer is more likely to be able to take immediate action to maintain their safety. Any change in the at least one environmental condition meeting the first criterion (e.g., a change that may impact the safety of the wearer) is automatically communicated to the wearer. As a result, the wearer is provided with an earlier warning of relevant changes (e.g., meeting the first criterion) in the at least one environmental condition, and so is more likely to be able to escape before the situation they face worsens. The techniques described herein therefore generally improve the safety of emergency responders. Additionally, the techniques described herein improve the safety of firefighters responding to wildland fires such as wildfires, forest fires, surface fires, crown fires, canopy fires, and/or bushfires.

### BRIEF DESCRIPTION OF THE DRAWINGS

Exemplary embodiments of the present disclosure will now be described, by way of example, and with reference to the accompanying drawings, in which:

FIG. 1 shows a schematic illustration of a network node according to one or more aspects of the disclosure;

FIG. 2 is a flow chart illustrating a method performed according to one or more aspects of the disclosure;

FIGS. 3 and 4 illustrate a system according to one or more aspects of the disclosure; and

FIG. 5 shows a block diagram illustrating a method performed according to one or more aspects of the disclosure.

### DETAILED DESCRIPTION OF THE DRAWINGS

As mentioned previously, burnovers and entrapments are two of the deadliest risks for wildland firefighting crews. These risks can arise from the occurrence of one or more of the following sequence of events: (i) a sudden change in weather conditions or fire behaviour occurs, (ii) the sudden change is poorly communicated or not communicated at all to the firefighting crews, (iii) the firefighting crews have an obstructed view of the fire and so cannot identify the sudden change themselves, and (iv) the firefighting crews have little to no warning to escape the fire.

The systems and methods described herein provide improved techniques which enable intervention in the above-mentioned sequence of events. Indeed, the techniques described herein can be used to automate the process of detecting changes in weather conditions and/or fire behaviour and relay corresponding information (e.g., alerts) to each individual member of a firefighting crew.

The systems and methods referred to herein involve a network node of a network. The network node may be any type of network node. More specifically, the network node may be a base station of the network described herein. The network node referred to herein may be configured to route communications between a wearable device and/or a wireless device, and other entities of the network. Herein, the network node can be any entity of the network which is configured to act as a transmitter or transceiver between a wearable device and another entity of the network (e.g. the wireless device referred to herein). Thus, in some examples, the network node referred to herein may be configured to operate as a repeater device between different entities of the network referred to herein. The network node referred to herein can be configured to initiate transmission of information towards the wearable device and/or other network nodes of the network. The network node can be referred to herein as a “hub” or a “base station” (e.g., of the network). The network node referred to herein may comprise at least one battery. For example, the network node referred to herein may be battery powered (e.g., by the at least one battery). The at least one battery may be at least one rechargeable battery. The at least one battery may comprise two (e.g., separate) batteries. As such, in some examples, the network node can be powered (e.g., in an alternating manner) by two separate batteries. The network node referred to herein may be a portable network node. For example, the network node may comprise one or more (e.g., fixed) handles. The one or more handles can be used to carry and/or lift the network node. In this way, the network node may be easily deployed at, and/or removed from, an emergency response incident. The network node referred to herein may be configured to obtain and/or determined information indicative of the location of the network node. The information indicative of the location of the network node may correspond to a geolocation of the network node. For example, the network node referred to herein can comprise a global navigation satellite systems (GNSS) module (e.g. receiver) and/or a global positioning system (GPS) module that is configured to obtain (e.g. receive) geolocation and/or time information. As such, in some examples, the plurality of network nodes referred to herein can be configured to obtain and/or determine location information associated with the emergency response incident.

The techniques described herein involve one or more wearable devices. A wearable device, as referred to herein, may be an electronic device that is configured to be worn (e.g., on the body). The wearable device may be an accessory, an implant, and/or an item of clothing. The wearable device referred to herein may be worn by an emergency responder while they are responding to an emergency response incident. The emergency responder may be, for example, a firefighter. The wearable device may take the form of a device worn on the body (e.g., of an emergency responder), such as a wrist worn device and/or an ankle worn device. The wearable device may additionally or alternatively be affixed to another article worn by a user (e.g., emergency responder) of the wearable device, such as an item of clothing and/or a breathing apparatus. The wearable device may be a lightweight device and/or a compact wearable device. In some examples, the wearable device referred to herein may comprise a smart device such as a smartwatch, and/or smart glasses. In some examples, the wearable device may be a portable device. For example, the wearable device may be a wireless device configured to be stored on a user (e.g., wearer) of the wearable device. The wearable device may be configured (e.g., dimensioned) to be stored in a pocket and/or a backpack of the user of the wearable device. The wearable device referred to herein may be configured to obtain and/or determined information indicative of the location of the wearable device. The information indicative of the location of the wearable device may correspond to a geolocation of the wearable device. For example, the wearable device referred to herein can comprise a global navigation satellite systems (GNSS) module (e.g. receiver) and/or a global positioning system (GPS) module that is configured to obtain (e.g. receive) geolocation and/or time information. As such, in some examples, the one or more wearable devices referred to herein can be configured to obtain and/or determine location information associated with the emergency response incident.

The systems and methods described herein may also involve a wireless device. The wireless device may be any type of wireless device. More specifically, the wireless device referred to herein may be any device configured to communicate wirelessly with one or more other entities (e.g., of the network referred to herein, such as the network node referred to herein). For example, the wireless device may be a user equipment (UE). The wireless device referred to herein can include, but is not limited to, a smart device such as a smartphone or a tablet. The wireless device can be configured to run an application (or “app”) which, for example, enables the wireless device to communicate with one or more network nodes of the plurality of network nodes referred to herein. The application may provide a user of the wireless device (e.g., an entry control officer, “ECO” and/or an incident commander, “IC”) with the ability to manage, control, and/or coordinate an emergency response, and in particular to monitor the transmission of alerts by network nodes as described herein. The wireless device may be configured to enable the user to create, edit and/or view emergency response information. For example, the wireless device may be configured to enable the user of the wireless device to view obtained information corresponding to an environmental condition in one or more bounding regions of respective one or more network nodes. Alternatively, or in addition, the wireless device may be configured to enable the user of the wireless device to view one or more parameters of a wearer of a wearable device as described herein. Such parameters may include information indicative of one or more of name, location, heart rate, breathing rate, and/or remaining air supply.

The techniques described herein involve a network. The network referred to herein can be any network, such as any communications or telecommunications network (e.g., cellular network). The network referred to herein may be a radio network. For example, the network referred to herein may be a 2.4 GHz radio network. In some examples, the network may comprise a Wi-Fi network (e.g., based on the Institute of Electrical and Electronics Engineers (IEEE) 802.11 family of standards). Alternatively, or in addition, the network may comprise a Bluetooth network (e.g., based on the IEEE 802.15.1 family of standards). Any one or more of the one or more wearable devices referred to herein, the plurality of network nodes referred to herein, and the wireless device referred to herein may communicate (e.g., directly, or indirectly) via the network described herein.

The techniques described herein involve an emergency response incident. An emergency response incident, as referred to herein, may be any type of emergency response incident. More specifically, an emergency response incident may be any incident which involves the addressing and/or resolving of an emergency. An emergency, as referred to herein, can be an urgent, unexpected, and/or dangerous situation. Alternatively, or in addition, an emergency response incident may pose an immediate risk to health, life, property, and/or environment. An emergency may require urgent intervention to prevent a worsening of the situation. Examples of the emergencies referred to herein include, but are not limited to, emergencies which pose a danger to life, a danger to health, a danger to property, and/or a danger to the environment. For example, the emergency referred to herein may include a fire related incident. In some examples, the emergency referred to herein may include a ground fire, such as a root fire. In some examples, the emergency referred to herein may include a surface fire. For example, the emergency referred to herein may include a wildfire, a wildland fire, a forest fire, and/or a bushfire. In some examples, the emergency referred to herein may include a crown fire, such as a canopy fire. Alternatively, or in addition, the emergency referred to herein may involve hazardous material operations (e.g., dealing with substances which are a risk to health, safety, property, and/or the environment).

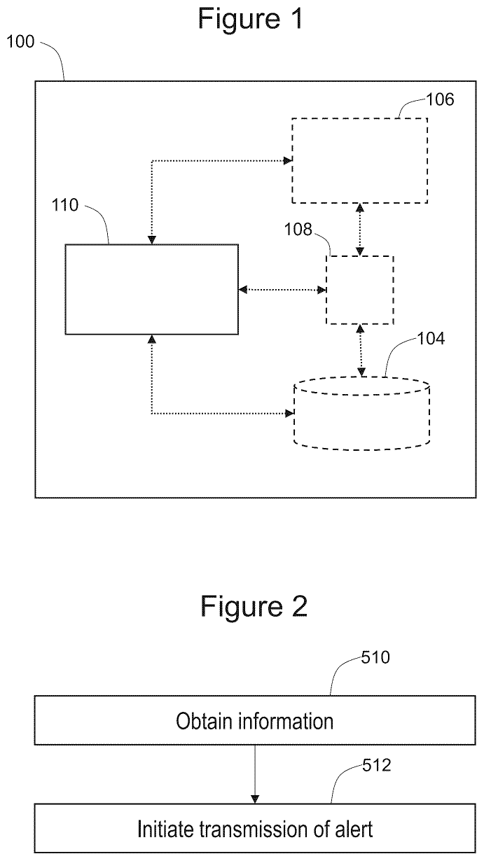

FIG. 1 illustrates a network node 100 according to an example embodiment. The network node 100 can be for monitoring an emergency response incident. The network node 100 can be a network node of the plurality of network nodes referred to herein. For example, each network node of the plurality of network nodes may be described with reference to the network node 100 of FIG. 1.

As illustrated in FIG. 1, the network node 100 comprises processing circuitry (or logic) 110. The processing circuitry 110 controls the operation of the network node 100 and can implement the method described herein in respect of the network node 100. The processing circuitry 110 can be configured or programmed to control the network node 100 in the manner described herein.

The processing circuitry 110 can comprise one or more hardware components, such as one or more processors (e.g., one or more microprocessors, one or more multi-core processors, and/or one or more digital signal processors (DSPs)), one or more processing units, one or more processing modules, and/or one or more controllers (e.g., one or more microcontrollers). The one or more hardware components can be arranged on one or more printed circuit board assemblies (PCBAs) contained in one or more housing components. The one or more hardware components may be configured or programmed (e.g., using software or computer program code) to perform the various functions described herein in respect of the network node 100. In particular implementations, each of the one or more hardware components can be configured to perform, or is for performing, individual or multiple steps of the method described herein in respect of the network node 100. The processing circuitry 110 can be configured to run software to perform the method described herein in respect of the network node 100. The processing circuitry 110 can thus be implemented in numerous ways, with software and/or hardware, to perform the various functions described herein in respect of the network node 100 and the system disclosed herein.

Briefly, the processing circuitry 110 of the network node 100 is configured to obtain information indicative of at least one environmental condition associated with a bounding region of the network node 100. The processing circuitry 110 of the network node 100 is also configured to, if the obtained information meets a first criterion, initiate transmission of an alert towards at least one wearable device of the one or more wearable devices.

As illustrated in FIG. 1, the network node 100 may optionally comprise a memory 104. Alternatively, the memory 104 may be external to (e.g., separate to or remote from) the network node 100. The memory 104 may comprise any type of non-transitory machine-readable medium, such as at least one cache or system memory. The memory 104 may comprise a volatile or a non-volatile memory. Examples of the memory 104 include, but are not limited to, a random access memory (RAM), a static RAM (SRAM), a dynamic RAM (DRAM), a read-only memory (ROM), a programmable ROM (PROM), an erasable PROM (EPROM), and an electrically erasable PROM (EEPROM), and/or any other memory.

The processing circuitry 110 can be communicatively coupled (e.g., connected) to the memory 104. The processing circuitry 110 may be configured to communicate with and/or connect to the memory 104. The memory 104 may be for storing program code or instructions which, when executed by the processing circuitry 110, cause the network node 100 to operate in the manner described herein. For example, the memory 104 may be configured to store program code or instructions that can be executed by the processing circuitry 110 to cause the network node 100 to operate in accordance with the method described herein in respect of the network node 100. Alternatively, or in addition, the memory 104 can be configured to store any information, data, messages, requests, responses, indications, notifications, signals, or similar, that are described herein. The processing circuitry 110 may be configured to control the memory 104 to store information, data, messages, requests, responses, indications, notifications, signals, or similar, that are described herein.

As illustrated in FIG. 1, the network node 100 may optionally comprise a sensor interface 106. The sensor interface 106 can be communicatively coupled (e.g., connected to the processing circuitry 110, and/or a communications interface 108. The sensor interface 106 may enable the network node 100 to communicate with one or more sensor or sensor modules (not shown). The one or more sensors may be integral to the network node 100 and/or separate devices. The one or more sensors may provide signal(s) corresponding to the at least one environmental condition described herein. For example, the one or more sensors may be configured to measure (e.g., a value of) the at least one environmental condition. The one or more sensors may include a temperature sensor, a humidity sensor, a particulate sensor, a wind speed sensor, a wind direction (e.g., heading) sensor, a gas concentration sensor, and/or a luminosity sensor. In some examples, the processing circuitry 110 can be configured to control the sensor interface 106 to operate in the manner described herein.

As illustrated in FIG. 1, the network node 100 may optionally comprise a communications interface (or communications circuitry) 108. The communications interface 108 can be communicatively coupled (e.g., connected) to the processing circuitry 110, the memory 104, and/or the sensor interface 106. Although the communications interface 108 and the sensor interface 106 are illustrated as separate interfaces, in other examples, the communications interface 108 may be part of the sensor interface 106 (or vice versa). The processing circuitry 110 may be configured to communicate with and/or connect to the communications interface 108. In some examples, the processing circuitry 110 can be configured to control the communications interface 108 to operate in the manner described herein. The communications interface 108 can be for enabling the network node 100, or components of the network node 100 (e.g., the processing circuitry 110, the memory 104, the sensor interface 106, and/or any other components of the network node 100), to communicate with and/or connect to each other and/or one or more other components. The communications interface 108 may enable the network node 100 to initiate transmission of an alert as described herein.

The communications interface 108 may be operable to allow the processing circuitry 110 to communicate with and/or connect to the memory 104 and/or vice versa. Similarly, the communications interface 108 may be operable to allow the processing circuitry 110 to communicate with and/or connect to the sensor interface 106 and/or vice versa. Similarly, the communications interface 108 may be operable to allow the processing circuitry 110 to communicate with and/or connect to any one or more other entities (e.g., the wireless device, the one or more wearable devices, or any other entity of the network) referred to herein whether via the network described herein or otherwise. The communications interface 108 may be operable to allow the processing circuitry 110 to communicate with and/or connect to a cloud server. The communications interface 108 can be configured to transmit and/or receive information, data, messages, requests, responses, indications, notifications, signals, or similar, that are described herein. The processing circuitry 110 may be configured to control the communications interface 108 to transmit and/or receive information, data, messages, requests, responses, indications, notifications, signals, or similar, that are described herein.

The communications interface 108 may enable the network node 100, or components of the network node 100, to communicate and/or connect in any suitable way. For example, the communications interface 108 may enable the network node 100, or components of the network node 100, to communicate and/or connect wirelessly, via a wired connection, or via any other communication (or data transfer) mechanism. In some wireless implementations, for example, the communications interface 108 may enable the network node 100, or components of the network node 100, to use radio frequency (RF), Wi-Fi, Bluetooth, or any other wireless communication technology to communicate and/or connect. In some wireless implementations, for example, the communications interface 108 may enable the network node 100, or components of the network node 100, to use ultra-high frequency (UHF) and/or very-high frequency (VHF) radio communication. In such implementations, transmission power may exceed 20 dB. In some implementations, proprietary radio communications techniques such as Long Range (LoRa) and/or LoRa Wide Area Network (LoRaWAN) may be used.

Although the network node 100 is illustrated in FIG. 1 as comprising a single memory 104, it will be appreciated that the network node 100 may comprise at least one memory (i.e., a single memory or a plurality of memories) 104 that operate in the manner described herein. Similarly, although the network node 100 is illustrated in FIG. 1 as comprising a single sensor interface 106, it will be appreciated that the network node 100 may comprise at least one sensor interface (i.e., a single sensor interface or a plurality of sensor interfaces) 106 that operate in the manner described herein. Similarly, although the network node 100 is illustrated in FIG. 1 as comprising a single communications interface 108, it will be appreciated that the network node 100 may comprise at least one communications interface (i.e., a single communications interface or a plurality of communications interfaces) 108 that operate in the manner described herein. It will also be appreciated that FIG. 1 only shows the components required to illustrate an example embodiment of the network node 100 and, in practical implementations, the network node 100 may comprise additional or alternative components to those shown.

The wireless device referred to herein may comprise the same or similar features of the network node 100 referred to herein. For brevity, these will not be repeated here. The wireless device may comprise a user interface. The user interface of the wireless device can be configured to output (e.g., render, display, and/or provide) information required by or resulting from the method described herein to function as part of the system described herein. For example, the user interface of the wireless device may be configured to output any information, data, messages, requests, responses, indications, notifications, signals, or similar, that are described herein. Alternatively, or in addition, the user interface of the wireless device can be configured to obtain (e.g., receive) a user input. For example, the user interface of the wireless device may allow a user to manually enter information or instructions, interact with, and/or control the wireless device. Thus, the user interface of the wireless device may be a user interface that enables the output of information and/or obtain a user input. For example, the user interface of the wireless device may be configured to display information indicative of at least one environmental condition (e.g., in a particular bounding region of a first geographical area). The user interface of the wireless device may be configured to display information indicative of a plurality of environmental conditions in a plurality of bounding regions of a first geographical area. Such information may, for example, be displayed as an overlay on a (e.g., cartographic) map of the first geographical area. The user interface of the wireless device may additionally or alternatively be configured to display information indicative of one or more characteristics of one or more wearers of the one or more wearable devices described herein.

The user interface of the wireless device may comprise one or more components for outputting information and/or one or more components for obtaining an (e.g., user) input. The one or more components for outputting (e.g., rendering) information can comprise one or more visual components (e.g. a display or display screen, a graphical user interface (GUI) such as a touch screen, one or more lights such as one or more light emitting diodes (LEDs), and/or any other visual component), one or more audio components (e.g. one or more speakers, and/or any other audio component), one or more haptic (e.g., tactile) components (e.g., a vibration function, or any other haptic feedback component), and/or any other components for outputting information, or combination of these components. The one or more components for obtaining a (e.g., user) input can comprise one or more visual components (e.g., one or more switches, one or more buttons, a keypad, a keyboard, a mouse, a graphical user interface (GUI) such as a touch screen, and/or any other visual component), one or more audio components (e.g. one or more microphones, and/or any other audio component), and/or one or more haptic (e.g., tactile) components (e.g., a vibration function, or any other haptic feedback component), or any other components for obtaining a user input, or combination of these components.

The one or more wearable devices referred to herein may comprise the same or similar features to the wireless device described herein. For brevity, these will not be repeated here. The one or more wearable devices may comprise a user interface. For example, the user interface of the one or more wearable devices may comprise a touchscreen user interface. The user interface of the one or more wearable devices may enable a wearer (e.g., a first responder) to report any hazards they encounter. Once a hazard report is made by a wearer via a wearable device, the wearable device may initiate transmission of information indicative of the hazard (hazard information) towards the wireless device via one or more network nodes of the plurality of network nodes referred to herein. In some examples, hazard information may be transmitted towards other wearable devices in the vicinity (e.g., either directly or indirectly via one or more network nodes of the plurality of network nodes referred to herein).

Hazard information may comprise information indicative of a nature of the hazard, a timestamp indicating a time at which the hazard was identified, and/or a location of the hazard. The hazard referred to herein may be any kind of hazard. in some examples, the hazard may correspond to a fire, fallen (or falling) tree and/or rock, wildlife, and/or people (e.g., trapped), dangerous chemicals, and/or exposed electrical equipment.

The user interface of the one or more wearable devices may additionally or alternatively comprise a means for initiating transmission of a distress alert. The means may comprise a button (e.g., a physical button or a touchscreen button) which, when pressed, initiates transmission of the distress alert. The wireless device may receive the distress alert (e.g., via one or more network nodes of the plurality of network nodes). The wireless device may output the distress alert to an ECO so that emergency assistance can be delivered to the wearer who initiated the distress alert.

The user interface of the one or more wearable devices may additionally or alternatively comprise a notification output means. The notification output means may be any means capable of outputting a notification to the wearer once a wearable device receives an alert. More specifically, the notification output means may include a speaker, a display (e.g., a touchscreen display), and/or a vibrational element.

The one or more wearable devices may comprise a sensor interface. The sensor interface may enable a sensor of a wearable device to communicate with a processing unit of the wearable device. In particular, the one or more wearable devices may include a physiological measurement sensor, such as a heart rate sensor, which communicates with the processing unit of the one or more wearable devices via a sensor interface. Information from the sensor interface of the one or more wearable devices may be transmitted via a communications interface of the one or more wearable devices towards the wireless device referred to herein. The wireless device may output the sensor information (e.g., heart rate information) on a user interface of the wireless device (e.g., for monitoring by an ECO).

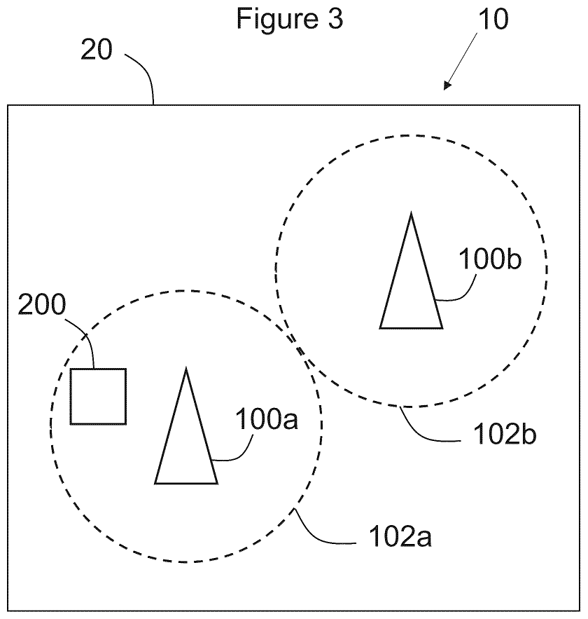

FIG. 2 is a flow chart illustrating a method performed according to an example embodiment. The method is for monitoring an emergency response incident. The network node 100 described herein (e.g., the network node 100 of FIG. 1) can be configured to operate in accordance with the method of FIG. 2. For example, the method can be performed by or under the control of the processing circuitry 110 of the network node 100. The method described herein may be a computer-implemented method.

With reference to FIG. 2, at block 510, the method comprises obtaining, by a network node 100 of a network, information indicative of at least one environmental condition associated with a bounding region of the network node 100. The network node 100 is one of a plurality of network nodes of the network, as defined herein. The plurality of network nodes are deployed at an emergency response incident, as defined herein. The plurality of network nodes is configured to provide network coverage in a first geographical area. The first geographical area comprises the bounding region of the network node 100.

Obtaining information indicative of at least one environmental condition associated with a bounding region may include measuring (e.g., using one or more sensors) the at least one environmental condition associated with the bounding region. For example, the network node 100 may include one or more sensors, as defined herein. The one or more sensors may be configured to measure the at least one environmental condition. Alternatively, or additionally, in some examples, the network node 100 may communicate (e.g., by the network and/or a communications interface 108 of the network node 100) with one or more additional sensors and/or sensor modules to obtain the information indicative of the at least one environmental condition associated with the bounding region. The one or more additional sensors and/or sensor modules may be comprised in the bounding region of the network node 100. The one or more additional sensors and/or sensor modules may be configured to receive (e.g., measure) information indicative of the at least one environmental condition within the bounding region.

An environmental condition, as referred to herein, may be any type of environmental condition. More specifically, an environmental condition may comprise a (e.g. measurable and/or detectable) physical state, chemical state, and/or biological state of the environment. An environmental condition may comprise a weather condition, a climate condition, and/or an atmospheric condition. A geographical area, as referred to herein, may be any geographical area. More specifically, a geographical area may be an area of land in which an emergency response incident is taking place. For example, a geographical area may comprise an area of woodland, bushland, forestland, meadow land, agricultural land, and/or urbanised land.

The at least one environmental condition may comprise one or more of wind speed, wind direction, humidity, temperature, sound, infrared radiation, ultraviolet radiation, carbon monoxide concentration, carbon dioxide concentration, volatile organic compounds concentration, oxygen concentration, and smoke particulate concentration. Humidity may include relative and/or absolute humidity. Temperature may include wet bulb temperature and/or dry bulb temperature. Volatile organic compound (VOC) concentration may include total volatile organic compounds (TVOC) concentration.

A bounding region of a network node, as referred to herein, may be a region (e.g., three dimensional volume) surrounding the network node. In some examples, the bounding region of a network node may correspond to the region (e.g., of the first geographical area referred to herein) that is within (e.g., network coverage) range of the network node. The bounding region of a network node may correspond to a volume within a certain distance (e.g., radius) of the network node. For example, the bounding region of a network node may correspond to any area and/or volume within 2 km of the network node. As mentioned herein, the network node 100 is one of a plurality of network nodes. In some examples, the bounding region of a network node may correspond to the region in which the network coverage signal provided by the network node is strongest (e.g., compared to each other network node of the plurality of network nodes). For example, if a wearable device of the one or more wearable device is in a region in which it can communicatively couple to either a first network node or a second network node, and the network coverage signal provided by the first network node is stronger than that of the second network node, the wearable device may be said to be comprised in the bounding region of the first network node.

As described herein, the plurality of network nodes and the one or more wearable device are deployed at an emergency response incident Herein, an entity may be said to be deployed at an emergency response incident if said entity is installed at, assigned to, stationed at, and/or dispatched to the emergency response incident. For example, a firefighter may install a network node in the vicinity of the emergency response incident. The one or more wearable devices referred to herein may be deployed at the emergency response incident by being worn by one or more emergency responders addressing the emergency response incident.

A geographical area, as referred to herein, may be any geographical area. For example, a geographical area may correspond to a portion of surface of the Earth. The first geographical area referred to here may be defined (e.g., bounded) by natural and/or man/made boundaries. The first geographical are referred to herein may vary in size and characteristics. For example, the first geographical may correspond to (e.g. comprise) an area of vegetation, such as a wildland, a forest, and/or a woodland.

As illustrated at block 512 of FIG. 2, the method comprises, if the obtained information meets the first criterion, initiating, by the network node 100, transmission of an alert towards at least one wearable device of one or more wearable devices of the network. Herein, the term “initiate” can mean, for example, cause or establish. Thus, any reference to an entity (e.g., the network node) “initiating transmission” will be understood to mean that the entity (e.g., processing circuitry of the entity) can be configured to itself transmit (e.g., via a communications interface of the entity) or can be configured to cause another entity to transmit. As described herein, the one or more wearable devices are deployed at the emergency response incident. The alert may comprise information indicative of the at least one environmental condition, and/or a change in the at least one environmental condition. In some examples, the alert may comprise instructions which are configured to cause the at least one wearable device to output the alert at the at least one wearable device.

Although not illustrated in FIG. 2, in some examples, the method may comprise determining, by the network node 100, which of the at least one wearable device of the one or more wearable devices of the network to transmit the alert towards. The determination may be based on which bounding region each of the one or more wearable devices is comprised (e.g., located) in. Although also not illustrated in FIG. 2, in some examples, the method may comprise identifying, by the network node 100, a change in the at least one environmental condition based on the obtained information. In some examples, the first criterion may be met if the change in the at least one environmental condition is indicative of a hazard in the bounding region.

Thus, in some examples, the network node 100 may be configured to identify the change in the at least one environmental condition based on the obtained information. In some examples, the first criterion may be met if the change in the at least one environmental condition is indicative of a hazard (e.g., a developing hazard) in the bounding region of the network node 100. Identifying a change in the at least one environmental condition may comprise identifying a rate of change in the at least one environmental condition.

A change in the at least one environmental condition may comprise an increase or a decrease in (e.g., a measured value of) the at least one environmental condition and/or an increase or a decrease in a rate of change of (e.g., a measured value of) the at least one environmental condition.

In some examples, obtaining the information indicative of the at least one environmental condition may comprise obtaining first information indicative of the at least one environmental condition in a first time interval, and obtaining second information indicative of the at least one environmental condition in a second time interval. The first time interval and the second time interval can be different. For example, the second time interval may occur after the first time interval. In some examples, identifying the change in the at least one environmental condition may comprise comparing the first information and the second information. For example, in scenarios in which the at least one environmental condition comprises temperature, the first information may be indicative of a lower temperature than the second temperature. In this example, identifying the change in the at least one environmental condition may comprise comparing the first and second information to identify a temperature increase between the first time interval and the second time interval. The network node 100 may, for example, determine that the temperature in the bounding region of the network node 100 is increasing based on this identification.

In some examples, the change in the at least one environmental condition may comprise an increase in wind speed, temperature, infrared radiation, ultraviolet radiation, carbon monoxide concentration, carbon dioxide concentration, volatile organic compounds concentration, and/or smoke particulate concentration. Alternatively, or in addition, in some examples, the change in the at least one environmental condition may comprise a decrease in humidity and/or oxygen concentration. Alternatively, or in addition, the change in the at least one environmental condition may comprise a change in wind direction and/or sound.

In some examples, the change in the at least one environmental condition may comprise an increase in: a positive rate of change of temperature, volatile organic compounds concentration, and/or smoke particulate concentration. Alternatively, or in addition, the change in the at least one environmental condition may comprise an increase in a negative rate of change of humidity.

A hazard in the bounding region, as referred to herein, may correspond to any potentially dangerous situation (e.g., for an emergency responder). For example, the hazard may correspond to a source of potential (e.g., human) harm and/or damage. The hazard may comprise one or more of a physical hazard, a chemical hazard, and a biological hazard. A physical hazard may comprise, for example, a fire hazard, an extreme temperature hazard, a noise hazard, and/or a falling object hazard. In some examples, the hazard may include (e.g., harmful and/or damaging) fire activity. Fire activity may include sparks, embers, flames, and/or smoke. The hazard may correspond to a change in fire activity, such as a change in fire path, an increase in fire size (e.g., area), and/or an increase in the rate of fire spread.

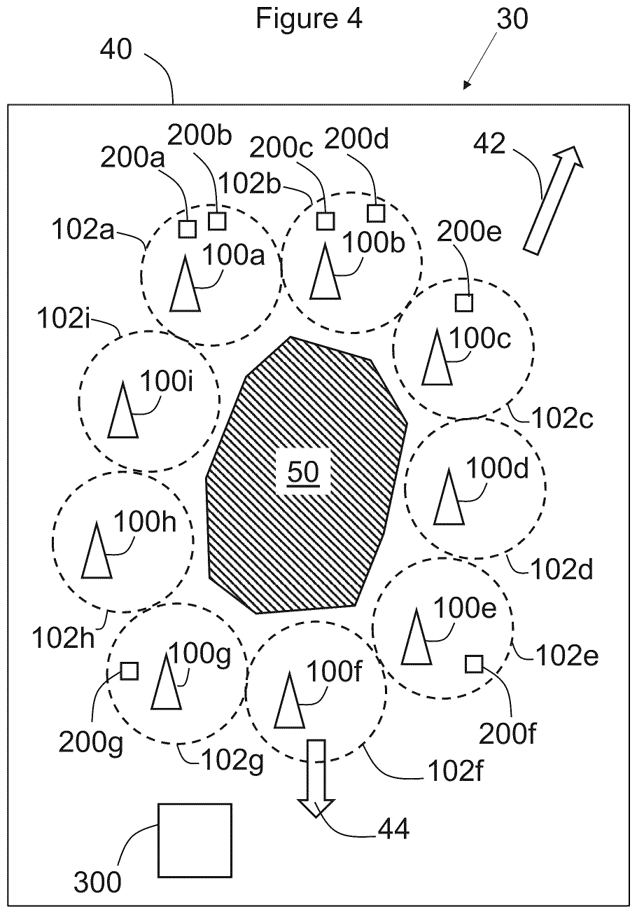

FIG. 3 illustrates a schematic view of a system 10 according to an example embodiment. The system 10 can be said to be deployed at an emergency response incident, as defined herein. As illustrated in FIG. 3, the system 10 comprises a plurality of network nodes 100a, 100b and one or more wearable devices 200. In this illustrated example, the plurality of network nodes 100a, 100b comprises a first network node 100a and a second network node 100b, and the one or more wearable devices 200 comprises a wearable device. It will be understood that the system illustrated in FIG. 3 is merely an example and that the plurality of network nodes 100a, 100b can comprise other numbers of (e.g., two or more) network nodes, according to other examples. As also illustrated in FIG. 3, the one or more wearable devices 200 can comprise one wearable device. However, it will be understood that this is merely an example and that the one or more wearable devices 200 may comprise any number of wearable devices.

As illustrated in FIG. 3, each of the first network node 100a and the second network node 100b are configured to provide network coverage in a first geographical area 20 of the emergency response incident. A network node (e.g., the first network node 100a and/or the second network node 100b) may be configured to provide network coverage by being configured as an access point of the network. For example, a network node may be configured to provide network coverage by being configured to operate as an access point for a wearable device (e.g., in the bounding region of the network node). For example, a network node may be configured to enable a wearable device to connect to the network, as referred to herein, and/or to enable the wearable device to communicate with one or more other entities of the network (e.g., the wireless device referred to herein). In some examples, the plurality of network nodes 100a, 100b may be configured as access points of a mesh network. For example, the plurality of network nodes 100a, 100b may provide multiple (e.g., network) pathways for communication (e.g., data transmission) to and/or from the emergency response incident. In this way, the plurality of network nodes 100a, 100b can maintain network coverage even in the event of a failure of an individual network node.

In some examples, each of the one or more wearable devices 200 may form a mesh network therebetween to convey information and/or alerts from one wearable device to any other wearable device. In some examples, the mesh network formed between each of the one or more wearable devices 200 may be separate to the mesh network formed by the plurality of network nodes 100a, 100b. In other example embodiments, the mesh network formed between each of the one or more wearable devices 200 may be formed as part of the mesh network formed by the plurality of network nodes 100a, 100b.

As illustrated in FIG. 3, each network node of the plurality of network nodes 100a, 100b can be associated with a bounding region. The first network node 100a can be associated with a first bounding region 102a and the second network node 100b can be associated with a second bounding region 102a. As illustrated in FIG. 3, in some examples, the bounding region of a network node may be a circular bounding region (e.g., with the network node at the centre). In other examples, the bounding region of a network node may form a different shape, such as square or hexagonal. In some examples, adjacent bounding regions (e.g., of neighbouring network nodes) may overlap such that a portion of the first geographical area is included in at least two bounding regions. In other examples, adjacent bounding regions may be shaped to fit together (e.g., tesselate) without overlapping.

It will be understood that the bounding regions shown in FIG. 3 are illustrative and that the bounding regions may be configured with other shapes, positions, sizes, and/or scales according to other examples.

Each of the one or more wearable devices 200 may each be comprised in at least one of the bounding regions. In this way, a network node of the plurality of network nodes may be configured to act as a network access point for any wearable devices comprised in the bounding region of the network node. In the example illustrated in FIG. 3, the wearable device is comprised (e.g., located) in the first bounding region 102a of the first network node 100a. Therefore, the first network node 100a can be configured to operate as a network access point for the wearable device (e.g., to enable the wearable device to communicate in the network). It will be understood that, if the wearable device was comprised (e.g., located) in the second bounding region 102b, then the second network node 100b can be configured to act as a network access point for the wearable device.

As described herein, each network node of the plurality of network nodes 100a, 100b is configured to obtain information indicative of at least one environmental condition associated with its (e.g., respective) bounding region. For example, with reference to FIG. 3, the first network node 100a can be configured to obtain information indicative of at least one environmental condition associated with the first bounding region 102a, and the second network node 100b can be configured to obtain information indicative of at least one environmental condition associated with the second bounding region 102b.

In a typical deployment, each bounding region may be up to several hundred metres (e.g., up to 500 m) in width. The obtained information may therefore be representative of the at least one environmental condition within the bounding region. Of course, the maximum ranges of radiocommunication equipment of each network node may be greater than the size of each bounding region.

As described herein, each network node of the plurality of network nodes 100a 100b is configured to initiate transmission of an alert towards at least one wearable device, as defined herein, if the obtained information meets a first criterion. In some cases, each network node of the plurality of network nodes 100a 100b can be configured to initiate transmission of the alert towards each wearable device comprised in the bounding region of the network node. For example, with reference to FIG. 3, if the first network node 100a obtains information that meets the first criterion, the first network node 100a can initiate transmission of the alert towards the wearable device comprised in the first bounding region 102a. In some examples, if the second network node 100b obtains information that meets the first criterion, the second network node 100b may not initiate transmission of the alert towards the wearable device comprised in the first bounding region 102a (e.g., as the wearable device is not comprised in the second bounding region 102b). In some examples, a network node may initiate transmission of an alert towards at least one wearable device not comprised (e.g., located) in the bounding region of the network node. In these examples, the transmitted alert may be (re)transmitted towards the wireless device by other (e.g., adjacent) network nodes of the plurality of network nodes until reaching the network node of the bounding region in which the at least one wearable device is comprised.

The one or more wearable devices referred to herein may be configured to receive the alert (e.g., as transmitted by a network node). The alert may include information indicative of the at least one environmental condition, a change in the at least one environmental condition, as defined herein, a timestamp of the change in the at least one environmental condition, and/or an instruction for the wearer(s) of the one or more wearable devices.

On receipt of the alert, the one or more wearable devices may be configured to notify the wearer(s) of the alert. Notifying a wearer of a wearable device may comprise outputting (e.g., displaying) a notification to the wearer. Such a notification may serve to distinctly and unambiguously convey an alert to the wearer of the wearable device. A notification may take the form of one or more sensory indicators including, but not limited to, lights, sounds, and/or haptics, or any combination thereof. The notification may be, for example, a whistle and/or a siren sound. Each wearable device of the one or more wearable devices may generate (e.g., output) the alert notification itself, for instance via a user interface of the wearable device (as described herein).

As described herein, a network node (e.g., the network node 100 as described with reference to FIG. 1) is configured to initiate transmission of an alert if obtained information, as defined herein, meets a first criterion. Several examples of the first criterion being met will now be described. Some of these examples can include changes to “primary indicators” which may be used to identify fire activity when considered in isolation. It will be appreciated that these examples are non-limiting and serve to illustrate some of the many possible implementations of the techniques described herein.

In some examples, the first criterion may be considered to be met if the obtained information is indicative of a carbon monoxide concentration of greater than or equal to 100 parts per million (PPM). In some examples, the first criterion may be considered to be met if the obtained information is indicative of a spike (e.g., rapid increase) in carbon monoxide concentration. The spike in carbon monoxide concentration may correspond to a change in carbon monoxide concentration from (e.g., at least) 20 PPM to over 100 PPM. A spike in carbon monoxide concentration may indicate fire activity including smoke and/or smouldering combustion. Carbon monoxide concentration may be a primary indicator, as defined herein.

In some examples, the first criterion may be considered to be met if the obtained information is indicative of a carbon dioxide concentration of greater than or equal to 100 PPM. In some examples, the first criterion may be considered to be met if the obtained information is indicative of a consistent increase in carbon dioxide concentration from at least around 50 PPM to around 100 PPM. Such a consistent increase in carbon dioxide concentration may be indicative of fire activity, such as flames. Carbon dioxide concentration may be a primary indicator, as defined herein.

In some examples, the first criterion may be considered to be met if the obtained information is indicative of a TVOC concentration of greater than or equal to 500 parts per billion (PPB). In some examples, the first criterion may be considered to be met if the obtained information is indicative of a TVOC spike of up to at least 500 PPB. Such a TVOC spike can be indicative of fire activity, such as flames. TVOC concentration may be a primary indicator, as defined herein.

In some examples, the first criterion may be considered to be met if the obtained information is indicative of a smoke particulate concentration of greater than or equal to 100 μg/m³. In some examples, the first criterion may be considered to be met if the obtained information is indicative of a smoke particulate spike of up to at least 100 μg/m³. Such as smoke particulate concentration may indicate fire activity. Smoke particulate concentration may be a primary indicator, as defined herein.

Additional “secondary indicators” of fire activity may also exist. In some examples, a secondary indicator may not be sufficient to meet the first criterion alone, but may result in the first criterion being met when combined with one or more other secondary indicators, and/or a primary indicator, such as the exemplary primary indicators described above.

A rise in temperature of at least between 1° C. and 3° C. over a span of 5 minutes may be a secondary indicator of fire activity. A fall in relative humidity of at least between 10% and 15% over a span of 1 hour could be a secondary indicator of fire activity. A rise in wind speed of at least between 2 m/s to 5 m/s over a span of 5 minutes could be a secondary indicator of fire activity. A sustained change in wind direction could be a secondary indicator of fire activity.

It will be appreciated that the configuration of the first criterion may differ, depending on the nature of the first geographical area, the emergency response incident, and/or the hazard. For example, a deployment of the system in a geographical area with a generally hot climate (e.g., 45 degrees Celsius in Nevada, US during the summer months) may necessitate a different first criterion to a deployment of a system in a first geographical area with a generally cool climate.

FIG. 4 illustrates a system 30 according to an example embodiment. The system 30 illustrated in FIG. 4 is an example of more complex system than the system shown in FIG. 3. The system illustrated in FIG. 4 may represent a more widescale deployment of the system as described with reference to FIG. 3. As illustrated in FIG. 4, the system 30 can be deployed at a first geographical area 40.

Within the geographical area 40 is a hazard 50, illustrated by hatched shading. The hazard 50 may be a fire hazard, such as a wildland fire. The hazard 50 may involve fire activity. The system 30 can be deployed to monitor the emergency response to the hazard 50 and thus improve the safety of emergency responders operating in the first geographical area 40.

Specifically, the system 30 can be deployed by deploying (e.g., installing) a plurality of network nodes 100a-100i, as described herein. As illustrated in FIG. 4, the plurality of network nodes 100a-100i can be deployed in an arrangement around the hazard 50. For example, the plurality of network nodes 100a-100i can be deployed around a perimeter of the hazard 50 (e.g., an area defined by the hazard 50). It will be understood that the deployment of the plurality of network node 100a-100i illustrated in FIG. 4 is merely an example, and that is not necessarily required for the plurality of network nodes 100a-100i to be deployed in an arrangement around the perimeter of the hazard 50. As illustrated in FIG. 4, each network node 100a-100i can be associated with a corresponding bounding region 102a-102i. In this way, emergency responders (e.g., wearers of the one or more wearable devices referred to herein) can move around the hazard 50 to engage the hazard 50 from all directions while staying within a bounding region, and thus in range of a network node to remain connected to the network.

As also illustrated in FIG. 4, the system comprises one or more wearable devices 200a-200g. As illustrated in FIG. 4, the one or more wearable devices 200a-200g can be comprised (e.g., located) in various bounding regions within the geographical area 40. For example, with reference to the system illustrated in FIG. 4, a first wearable device 200a and a second wearable device 200b of the one or more wearable devices 200a-200g can be comprised (e.g., located) in the first bounding region 102a of the first network node 100a.

As discussed with reference to FIG. 3, each wearable device of the one or more wearable devices 200a-200g can be worn by an emergency responder (e.g., a firefighter). Therefore, the system illustrated in FIG. 4 can be understood to schematically illustrate which bounding region each emergency responder is comprised (e.g., located) in.

As described herein, each network node of the plurality of network nodes 100a-100i is configured to obtain information indicative of at least one environmental condition associated with a corresponding bounding region of the network node. Each network node of the plurality of network nodes 100a-100i may then determines whether to initiate transmission of an alert towards at least one wearable device of the one or more wearable devices 200a-200g based on whether the obtained information meets a first criterion, as defined herein.

In an illustrative example, the second network node 100b may obtain information indicative of at least one environmental condition, such as a wind direction, in the second bounding region 102b. The obtained information may indicate that the wind direction in the second bounding region 102b has changed to point in the direction of arrow 42. This change may be sustained rather than momentary and may therefore be determined (e.g., interpreted) by the second network node 102b as meeting the first criterion.

As a result, the second network node 100b may initiate transmission of an alert, as defined herein, towards at least one wearable device of the one or more wearable devices 200a-200g. For example, the second network node 100b may selectively initiate transmission of the alert towards wearable devices worn by emergency responders who may benefit from being made aware of this change in environmental conditions. In particular, as a third wearable device 200c and a fourth wearable device 200d would be considered downwind of the hazard 50 (and potentially in the path of the hazard 50 were the change in wind direction to cause the hazard 50 to move), the second network node 102b may initiate transmission of the alert towards each of the third wearable device 200c and the fourth wearable device 200d.

The third wearable device 200c and the fourth wearable device 200d may each be configured to receive the alert transmitted by the second network node 102b.

On receiving the alert, the third wearable device 200c and the fourth wearable device 200d may generate a notification. As such, the notification may be provided to the respective wearer of the third wearable device 200c and the fourth wearable device 200d. The notification may serve to distinctly and/or unambiguously convey the alert to the wearer of the wearable device. A notification may take the form of one or more sensory indicators including, but not limited to, lights, sounds, and/or haptics, or any combination thereof. The notification may be, for example, a whistle and/or a siren sound. The at least one wearable device may generate the alert notification, for example, via a user interface of the at least one wearable device.

In this particular example, the notification may provide (e.g., contextual) information indicative of the at least one environmental condition that meets the first criterion (e.g., the change in wind direction).

In some examples, the second network node 100b may initiate transmission of the alert towards each of the one or more wearable devices 200a-200g (e.g., indiscriminately). In response to receiving the alert, each wearable device of the one or more wearable devices 200a-200g may determine whether to generate a (e.g., corresponding) notification. As such, each wearable device of the one or more wearable devices 200a-200g may determine whether to notify the wearer (e.g., the emergency responder). The determination performed by the wearable device may be based on which bounding region 102a-102i the wearable device 200a-200g is comprised in.

Another illustrative example will now be described with reference to the system 40 illustrated in FIG. 4. In some examples, at least one of the bounding regions 102a-102i may include an (e.g., designated) escape route. Such an escape route may be an emergency escape route. The escape route may be configured to be used by wearers (e.g., emergency responders) of the one or more wearable devices 200a-200g if they are required to quickly escape from a particular area. For example, as illustrated in FIG. 4, a sixth bounding region 102f of a sixth network node 100f may include an escape route 44. The escape route 44 may be designated for use by wearers of wearable devices in any adjacent and/or neighbouring bounding regions of the sixth bounding region 102f. For example, the escape route 44 may be designated for use by a sixth wearable device 200f comprised in a fifth bounding region 102e and a seventh wearable device 200g comprised in a seventh bounding region 102g.

As described herein, each network node of the plurality of network nodes 100a-100i can be configured to determine a condition of an escape route, at least partially comprised in the bounding region of the network node, based on the obtained information, as defined herein. If the condition of the escape route is determined to be unstable, the network node can initiate transmission of an evacuation instruction towards each wearable device in the bounding region of the network node. In some examples, the condition of the escape route being determined to be unstable may be indicative that the accessibility of the escape route may decrease (e.g., in the near future) and/or is decreasing. In some examples, a condition of an escape route may be determined to be unstable if the escape route is only accessible for a remaining period of time. In some examples, a condition of an escape route may be determined to be unstable if the escape accessibility of the escape route is uncertain. As an example, with reference to FIG. 4, if a seventh network node 100g can obtain information indicative of, for example, an (e.g., sudden) increase in smoke particulate concentration in the seventh bounding region 102g the seventh network node 100g may determine that the condition of the escape route 44 is unstable based on the obtained information. In response, the seventh network node 100g may initiate transmission of an evacuation instruction towards a seventh wearable device 200g. On receipt of the evacuation instruction, the seventh wearable device 200g may generate a notification of the evacuation instruction. The notification of the evacuation instruction may instruct the user to evacuate from the seventh bounding region 102g via the escape route 44 in the adjacent sixth bounding region 102f. The notification of the evacuation instruction may be indicative of an amount of time in which to evacuate (e.g., an evacuation timer). The amount of time in which to evacuate may correspond to an amount of time to elapse until the escape route 44 is determined to be unstable, inaccessible, and/or (e.g., prohibitively) unsafe. In this way, the evacuation instruction can notify a first responder that a (e.g., solitary) escape route must be utilised (e.g., before it is too late).

In some examples, if the seventh network node 100g determines that the condition of the escape route 44 is unstable, the seventh network node 100g may initiate transmission of a message towards the one or more wearable devices 200a-200g containing instructions to use an alternate escape route.

A network node with an escape route comprised in its bounding region may determine a condition of the escape route based on various information. For example, the obtained information may be used to determine (e.g., assess) whether the escape route is stable or unstable. Alternatively, or in addition, other data such as satellite imagery may be used to determine whether the escape route is stable or unstable.

A condition of an escape route may be considered “stable” if the escape route is not currently impinged by a hazard such as fire activity. A condition of an escape route may also be considered “stable” if the escape route is not predicted to become impinged by fire activity within a given timeframe.

A condition of an escape route may be considered “unstable” if the escape route is currently impinged by fire activity and/or if the escape route is predicted to become impinged by fire activity within a given timeframe.

The condition of an escape route may be determined according to multiple indicators, such as one or more primary indicators combined with one or more secondary indicators as described herein. The greater the number of indicators suggesting that the condition of an escape route is stable, the more confidence may be placed on the escape route being deemed stable (and vice versa).

Where a network node, such as the sixth network node 100f, determines that an alert must be transmitted towards a wearable device not currently within its bounding region (e.g., sixth bounding region 102f), the network node may transmit the alert towards the wearable device via one or more additional network nodes of the plurality of network nodes 100a-100i. In this way, the network nodes may form a mesh to enable transmission of an alert from any network node to any wearable device, regardless of which bounding region the wearable device is comprised in.

As illustrated in FIG. 4, in some examples, the system 40 may comprise a wireless device 300, as defined herein. The wireless device 300 can be of the network, as defined herein. The wireless device 300 may act as a bridge to enable a coordinator of the emergency response incident to communicate with the plurality of network nodes 100a-100i. For example, the wireless device 300 may be operated by an emergency control officer (ECO) and/or an incident commander (IC).

Whenever a network node initiates transmission of an alert towards one or more wearable devices, the network node may additionally initiate transmission of the alert towards the wireless device 300. The wireless device 300 may receive any alerts transmitted towards it. Information contained within the alert may be presented on a user interface of the wireless device 300, according to some examples.

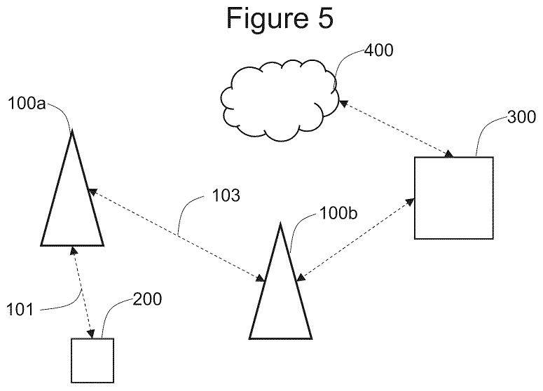

FIG. 5 illustrates a schematic view of a system (e.g., network) according to an example embodiment. FIG. 5 illustrates an example manner in which the system as described with reference to FIG. 3 can be put into effect in order to achieve the above described, and/or additional, functionality. As illustrated in FIG. 5, in some examples, the system can comprise a wireless device 300, as defined herein. In the example illustrated in FIG. 5, the plurality of network nodes 100a, 100b comprises two network nodes, however it will be understood that this is merely an example.

As illustrated by arrow 101 of FIG. 3 (and as described herein), the first network node 100a can initiate transmission of an alert towards at least one wearable device 200, as defined herein. As also illustrated by arrow 101 of FIG. 3, the first network node 100a can obtain (e.g., receive) information from the at least one wearable device 200. The first network node 100a may act as a transceiver for the at least one wearable device 200. For example, the first network node 100a may be configured to (re)transmit any information received from the at least one wearable device 200 to any other entity of the network. In some examples, the first network node 100a may be configured to (re)transmit any information received from another network node of the plurality of network nodes 100a, 100b to the at least one wearable device 200. For example, as illustrated by arrow 103 of FIG. 5, the first network node 100a may act as a transceiver for communication between the at least one warble device 200 and the second network node 100b. It will be understood that the information (re)transmitted by each network node of the plurality of network nodes 100a, 100b may comprise the same information (e.g., as the information received by the network node). In some examples, the information (re)transmitted by each network node of the plurality of network nodes 100a, 100b may be parsed, formatted and/or structured (e.g., by each network node) after information receipt and before (re)transmission. For example, the (re)transmission of information as described with reference to arrow 103 of FIG. 5 may be performed wirelessly via a radio network, whereas the (re)transmission of information as described with reference to arrow 101 of FIG. 5 may be performed wirelessly via a Wi-Fi network. In some examples, the first network node 100a and/or the second network node 100b may perform a conversion of the structure of the information received from and/or transmitted to the at least one wearable device 200 to a format suitable for (re)transmission. It will be understood that the information (e.g., transmitted as described with reference to arrow 101 and/or arrow 103 of FIG. 5) may be compressed (e.g., in any way) or uncompressed. In examples in which the transmitted information comprises compressed information, the plurality of network nodes 100a, 100b may be configured to decompress and/or recompress the information for (re)transmission to the at least one wearable device 200 and/or the wireless device 300. The wireless device 300 (e.g., the processing circuitry 102 of the wireless device 100) may be configured to decompress, decode, and/or decrypt the information (e.g., received from the plurality of network nodes 100a, 100b).

Each network node of the plurality of network nodes 100a, 100b may act as a repeater (e.g., to (re)transmit information) between a wearable device of the one or more wearable devices and another network node of the plurality of network nodes 100a, 100b. If a particular network node in a network becomes inoperable, the network may automatically reconfigure to enable information transmission via an alternate route. Thus, critical information can be relayed even when a connection between adjacent network nodes fails.

As illustrated in FIG. 5, in some examples, the system may comprise a cloud entity 400 of the network. The cloud entity 400 may be a cloud server. The wireless device 300 may (e.g., directly, and/or indirectly) communicate with the cloud entity 400 to store and/or retrieve information, and/or to offload processing tasks. The cloud entity can be configured to operate as a backup (e.g., storage) for information generated and/or communicated by the system.

There is also provided a computer program comprising instructions which, when executed by processing circuitry (such as the processing circuitry 102 of the network node 100 described herein), cause the processing circuitry to perform at least part of the method described herein. There is provided a computer program product, embodied on a non-transitory machine-readable medium, comprising instructions which are executable by processing circuitry (such as the processing circuitry 102 of the network node 100 described herein) to cause the processing circuitry to perform at least part of the method described herein. There is provided a computer program product comprising a carrier containing instructions for causing processing circuitry (such as the processing circuitry 102 of the network node 100 described herein) to perform at least part of the method described herein. In some examples, the carrier can be any one of an electronic signal, an optical signal, an electromagnetic signal, an electrical signal, a radio signal, a microwave signal, or a computer-readable storage medium.

According to the systems and methods described herein, it will be appreciated that by providing a wearer of a wearable device with more rapid notice of a change in a hazard, the wearer is more likely to be able to move to a safe location. Therefore, the systems and method described herein can improve the safety and survivability outcomes for emergency responders (e.g., firefighters) when responding to emergency response incidents.

Additionally, by designating and automatically monitoring conditions of escape routes, first responders can be more quickly notified when escape, either via their designated escape route or an alternative escape route, is necessary.

Furthermore, by enabling the relaying of information to a wireless device (e.g., of a command post) as described herein, an ECO is able to more accurately monitor and track statuses and positions of emergency responders in real time. The wireless device also enables an ECO to visualise (e.g., in real time) environmental (e.g., condition) information obtained by each network node of the plurality of network nodes deployed at the emergency response incident. In this way, some of the techniques described herein eliminate the need for first responders to manually communicate updates (e.g., via radio and/or walkie-talkie).

It will be appreciated by those skilled in the art that, although the invention has been described by way of example and with reference to one or more exemplary embodiments, it is not limited to the disclosed example embodiments and alternative embodiments could be constructed and/or implemented without departing from the scope of the invention as defined by the appended claims.

1. A system for monitoring an emergency response incident, the system comprising:
one or more wearable devices of a network, wherein the one or more wearable devices are configured to be deployed at the emergency response incident; and
a plurality of network nodes of the network, wherein the plurality of network nodes is configured to be deployed at the emergency response incident;
wherein the plurality of network nodes is configured to provide network coverage in a first geographical area of the emergency response incident; and
wherein each network node, of the plurality of network nodes, is configured to:
obtain information indicating at least one environmental condition associated with a bounding region of a respective network node, wherein the first geographical area comprises the bounding region; and
initiate, based on the obtained information meeting a first criterion, transmission of an alert to at least one wearable device of the one or more wearable devices.

2. The system of claim 1, wherein each wearable device, of the one or more wearable devices, is located in at least one bounding region of a respective network node of the plurality of network nodes.

3. The system of claim 2, wherein each network node, of the plurality of network nodes, is configured to:
initiate, based on the obtained information meeting the first criterion, transmission of the alert to each wearable device, of the one or more wearable devices, located in the at least one bounding region.

4. The system of claim 1, wherein each network node, of the plurality of network nodes, is configured to:
identify a change in the at least one environmental condition based on the obtained information,
wherein the first criterion is met if the change in the at least one environmental condition is indicative of a hazard in the bounding region.

5. The system of claim 4, wherein the change in the at least one environmental condition comprises one or more of:
an increase in wind speed;
an increase in humidity;
an increase in temperature;
an increase in infrared radiation;
an increase in ultraviolet radiation;
an increase in carbon monoxide concentration;
an increase in carbon dioxide concentration;
an increase in volatile organic compounds concentration;
an increase in oxygen concentration;
an increase in smoke particulate concentration;
a decrease in wind speed;
a decrease in humidity;
a change in wind direction; or
a change in sound.

6. The system of claim 1, wherein the at least one environmental condition comprises one or more of:
wind speed;
wind direction;
humidity;
temperature;
sound;
infrared radiation;
ultraviolet radiation;
carbon monoxide concentration;
carbon dioxide concentration;
volatile organic compounds concentration;
oxygen concentration; or
smoke particulate concentration.

7. The system of claim 1, wherein:
the first geographical area comprises an escape route; and
a first network node, of the plurality of network nodes, is configured to:
determine, based on a determination that a first bounding region associated with the first network node at least partially comprises the escape route, a condition of the escape route based on the obtained information; and
initiate, based on a determination that the condition of the escape route is unstable, transmission of an evacuation instruction to each wearable device in the first bounding region of the first network node.

8. The system of claim 7, wherein the one or more wearable devices are configured to:
generate, in response to receiving the evacuation instruction, a notification indicating that the escape route is unstable.

9. The system of claim 1, further comprising:
a wireless device comprising a user interface,
wherein each network node of the plurality of network nodes is configured to:
initiate, based on the obtained information meeting the first criterion, transmission of the alert to the wireless device.

10. The system of claim 1, wherein the at least one wearable device is configured to:
generate, in response to receiving the alert, a notification indicating that the obtained information meets the first criterion.

11. The system of claim 1, wherein each network node, of the plurality of network nodes, comprises at least one sensor configured to obtain the information indicating the at least one environmental condition.

12. The system of claim 1, wherein the emergency response incident comprises one or more of:
a fire;
a ground fire;
a crown fire;
a wildfire;
a wildland fire;
a forest fire; or
a bushfire.

13. A method for monitoring an emergency response incident, the method comprising:
obtaining, by a network node of a network, information indicating at least one environmental condition associated with a bounding region of the network node, wherein:
the network node is one of a plurality of network nodes of the network;
the plurality of network nodes is configured to be deployed at the emergency response incident;
the plurality of network nodes is configured to provide network coverage in a first geographical area; and
the first geographical area comprises the bounding region; and
initiating, by the network node and based on the obtained information meeting a first criterion, transmission of an alert to at least one wearable device of one or more wearable devices of the network, wherein the one or more wearable devices are configured to be deployed at the emergency response incident.

14. The method of claim 13, further comprising:
identifying, by the network node and based on the obtained information, a change in the at least one environmental condition,
wherein the first criterion is met if the change in the at least one environmental condition is indicative of a hazard in the bounding region.

15. The method of claim 13, further comprising:
determining, based on a determination that a bounding area associated with the network node comprises an escape route, a condition of the escape route based on the obtained information; and
initiating, based on a determination that the condition of the escape route is unstable, transmission of an evacuation instruction to each wearable device in the bounding region of the network node.

16. The method of claim 15, further comprising:
generating, in response to receiving the evacuation instruction, a notification indicating that the escape route is unstable.

17. A non-transitory machine-readable medium comprising instructions that, when executed, cause:
obtaining, by a network node of a network, information indicating at least one environmental condition associated with a bounding region of the network node, wherein:
the network node is one of a plurality of network nodes of the network;
the plurality of network nodes is configured to be deployed at an emergency response incident;
the plurality of network nodes is configured to provide network coverage in a first geographical area; and
the first geographical area comprises the bounding region; and
initiating, by the network node and based on the obtained information meeting a first criterion, transmission of an alert to at least one wearable device of one or more wearable devices of the network, wherein the one or more wearable devices are configured to be deployed at the emergency response incident.

18. The non-transitory machine-readable medium of claim 17, wherein the instructions, when executed, cause:
identifying, by the network node and based on the obtained information, a change in the at least one environmental condition,
wherein the first criterion is met if the change in the at least one environmental condition is indicative of a hazard in the bounding region.

19. The non-transitory machine-readable medium of claim 17, wherein the instructions, when executed, cause:
determining, based on a determination that a bounding area associated with the network node comprises an escape route, a condition of the escape route based on the obtained information; and
initiating, based on a determination that the condition of the escape route is unstable, transmission of an evacuation instruction to each wearable device in the bounding region of the network node.

20. The non-transitory machine-readable medium of claim 19, wherein the instructions, when executed, cause:
generating, in response to receiving the evacuation instruction, a notification indicating that the escape route is unstable.
